(19) United States
(12) Patent Application Publication
(10) Pub. No.: US 2012/0179984 A1
(43) Pub. Date: Jul. 12, 2012

(54) UNIVERSAL PAGING SYSTEM FOR HTML CONTENT

(75) Inventor: Alexander Kordun, Arlington, MA (US)

(73) Assignee: INTERNATIONAL BUSINESS MACHINES CORPORATION, Armonk, NY (US)

(21) Appl. No.: 13/004,773

(22) Filed: Jan. 11, 2011

(51) Int. Cl. G06F 3/048

(52) U.S. Cl. 715/760

(57) ABSTRACT

A computer program product, including a computer readable storage medium to store a computer readable program, wherein the computer readable program, when executed by a processor within a computer, causes the computer to perform operations for universal paging in a web browser. The operations include: identifying a list of paging controls for paging through a plurality of pages of Hypertext Markup Language (HTML) content; binding the list of actions to a set of mouse actions to a mapping stored on a memory device, wherein each mouse action is bound to one of the paging controls in the list; and implementing the paging controls for web pages displayed on a display device in response to corresponding mouse actions from the mapping, wherein the web pages are encoded to recognize the mapping.

### BACKGROUND

Websites on the Internet are evolving into rich repositories of information with various sections, each having a paged list of content. Because designs of each website may be very different in both style and quality, from a human-computer interaction perspective, users often find it difficult to determine how to page through the content and may find it cumbersome to page though the content quickly or often, especially in sites where the web site contains a large body of data and it becomes necessary to view the data or sites by performing many paging operations.

Paging controls are very diverse in size and style. Moreover, the page structure often forces the user to resize or manipulate the browser window scroll bar each time the user wants to page the content in different sections. The boundaries of these various sections are not always clear on a website, how the sections are interrelated, or which sections of the screen actually represent a paged content rather than static, textual or graphical information. A universal paging system may allow users to navigate more easily through a variety of websites, and may also provide better/quicker paging for visually impaired users.

### SUMMARY

Embodiments of a system are described. In one embodiment, the system is a universal paging system for web browsing on a computing device, the system comprising: a mouse listener to listen for mouse actions; a mapping data structure stored on a memory device, wherein the mapping data structure comprises a list of paging controls bound to a set of mouse actions, wherein the paging controls are for paging through a plurality of pages comprising Hypertext Markup Language (HTML) content, wherein each mouse action is bound to one of the paging controls in the list; and a browser interface displayed on a display device to download and parse web content, wherein the browser interface is also configured to implementing the paging controls in response to corresponding mouse actions from the mapping for web pages that are encoded to recognize the mapping. Other embodiments of the system are also described. Embodiments of a computer program product and a method are also described. Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a universal paging system.

FIG. 2 depicts a schematic diagram of one embodiment of the browser of FIG. 1.

FIG. 3 depicts a schematic diagram of one embodiment of the universal paging system of FIG. 1.

FIG. 4 depicts a flow chart diagram of one embodiment of a method for universal paging in a web browser.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments present a universal paging system for web browsing on a computing device. More specifically, the system includes a user or browser profile that contains a mapping of a list of paging controls to mouse actions. The system parses downloaded Hypertext Markup Language (HTML)-based web content and determines if the content is compatible with the mapping in the profile, and if the content is compatible, the system allows the user to implement the various paging controls using the mouse actions in the mapping. The system also allows the implementation of the paging controls in different collections in a single web page.

Conventional systems allow a user to interact with a mouse to navigate and execute various actions on a screen depending on the location of the mouse pointer. Such actions typically include scrolling content, resizing, closing, opening content quickly on the desktop, and other actions. Most web browsers also typically bind these controls to common operations dealing with browser history, such as Back, Forward, Home, etc. However, while these are useful for general navigation of the history in the web browser, they are not helpful in paging through paged content.

Some web sites have provided keyboard shortcuts (not mouse shortcuts) to perform common operations specifically for the user experience. While keyboard shortcuts are useful, this support is not standard across other sites using markup and requires a user to learn site-specific sets of hot-keys and, of course, to use a keyboard. Screen readers for visually impaired people allow users to tab to a paging control, listen for it to be announced, and then repeatedly execute the control to page through the content. This is also limited because of the sequential tabbing requirement, the necessity of a keyboard, and non-standard markup across different web sites. Consequently, conventional systems do not provide mouse-activated, universal paging controls for HTML-based content on the web.

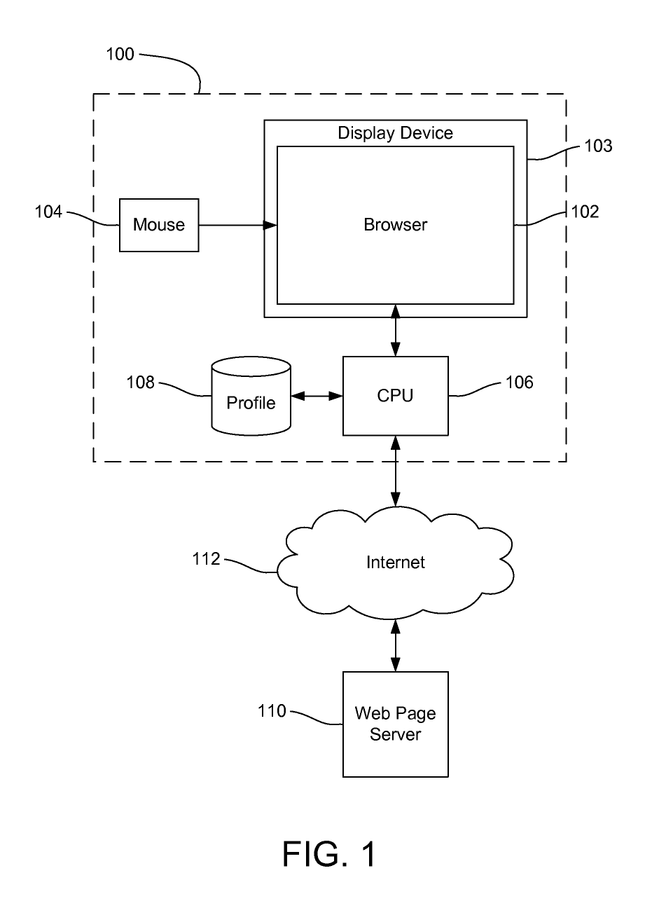

FIG. 1 depicts a schematic diagram of one embodiment of a universal paging system 100. The illustrated universal paging system 100 includes a web browser 102 displayed on a display device 103, a mouse 104, a processing device 106, and a profile 108. Although the universal paging system 100 is shown and described with certain components and functionality, other embodiments of the universal paging system 100 may include fewer or more components to implement less or more functionality.

The universal paging system 100 allows a user to interact with a web browser 102—also referred to herein as a browser interface 102—using a mouse 104 in order to page through paged content in a web page. The browser 102 is displayed on a computing device having a processor 106. In one embodiment, the processor 106 has access to a locally stored profile 108. The profile 108 may include a mapping of paging controls to mouse actions. The system 100 binds the mouse actions to the paging controls such that when the user performs the mouse actions, the browser 102 implements the paging controls according to the one-to-one mapping, with each mouse action being bound to a single paging control.

In one embodiment, the computing device in the universal paging system 100 is in communication with a web page server 110. The computing device may access the web page server 110 through an Internet connection 112 or other connection to download content stored on the server 110 corresponding to a web page that the user views in the browser 102. The content is parsed by the processor 106 to determine if the web page is compatible with one or more of the paging controls listed in the mapping. Upon determining that the paging controls are compatible with the web page, the user is then able to implement the paging controls by performing the mouse actions.

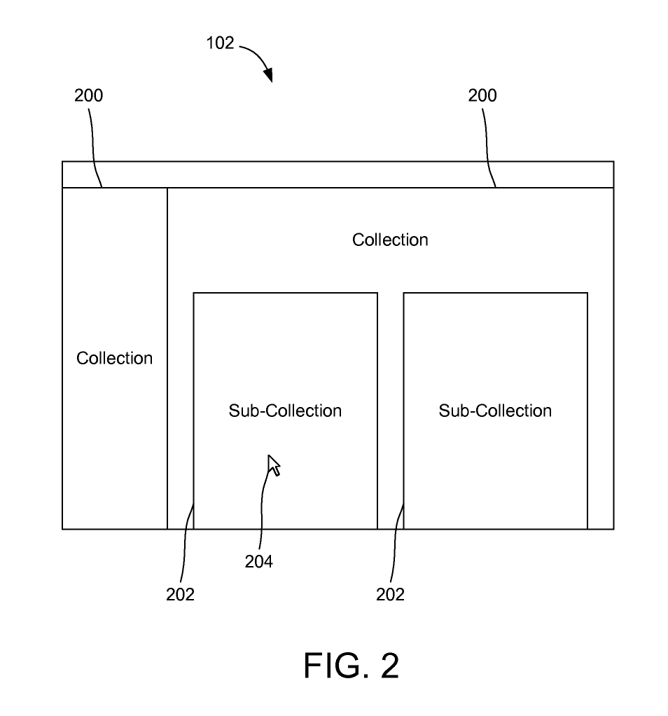

FIG. 2 depicts a schematic diagram of one embodiment of the browser 102 of FIG. 1. After the computing device contacts the web page server 110 and downloads the content for the page, the web browser 102 displays the web page content in a window. As computing devices and Internet speeds improve, web programming languages introduce new capabilities to web developers. This allows web pages to become more interactive and complex.

In some embodiments, web sites include multiple sections within a single page. Each section may include different content with which the user may interact. In conventional systems, web pages that include more than one section with interactive content may not be able to implement paging controls using keyboard shortcuts, where the system 100 is able to recognize which section the user desires to page using the specific shortcut. For example, a particular keyboard shortcut for a web email client opens a new message for composition, if the client also includes another section that has paging controls in the same window, the keyboard shortcut is unable to implement a paging control in the other section. Additionally, the keyboard shortcuts for the web page are specifically implemented in the web page by developers, such that they are not universally implemented by the browser in web pages not related to the specific web site.

In one embodiment, the system 100 allows for default paging controls in HTML. For example, HTML5—a specific version of HTML—supports link relations specifically for designating links corresponding to paging controls, including “last”, “start”, “first”, “previous”, “next”, and “index” which may be used for some of the paging controls described herein. The system may allow for the introduction of other relations corresponding to paging controls not currently inherently supported by HTML5, including “all” for viewing all the paged content within a single collection. Because the system allows such link relations, a web developer may be able to include JavaScript call actions in the HTML code for such elements to more complicated logic.

Because the web page may include different sections, the web site HTML code may contain a complex hierarchy to identify each section such that the system is able to distinguish one section from another and implement the universal paging controls accordingly. In one embodiment of the present system, each different section—or collection 200—of paged content is identified as a “collection” relation in the HTML code for the web page. Each collection 200 may be added to a division, table, or any other container enclosure in the HTML code to indicate a piece of screen real estate that is responsible for showing paged items.

In one embodiment, the paging controls include a collection relation corresponding to a document object model (DOM) element for each of the collections 200. Each DOM element may also have a corresponding name attribute that is stored in the HTML code in addition to the collection relation paging control. When a mouse hovers over a collection 200 with a specific collection relation and name attribute, the browser 102 may activate and visually emphasize the section of web content corresponding to the collection 200. In one embodiment, the browser 102 voices the name attribute such that visually impaired users may be able to know which collection 200 is being paged. For example, the system 100 may highlight a collection 200 by lighting the section borders in a contrasting color. In another embodiment, the system 100 also displays the value of the name attribute on the screen so that the user is more easily able to know which collection 200 is currently activated. The paging controls in the currently activated collection 200 may then be implemented for the corresponding mouse actions in the stored mapping as long as the mouse pointer remains anywhere within the borders of the currently activated collection 200. All other mouse actions or events not bound to a paging control may still be respected and implemented by the browser 102, such that there is no conflict with any existing or additional JavaScript logic on the web page.

In one embodiment, one or more of the collections 200 contains nested sub-collections 202, such that the web page has at least one sub-collection 202 within another collection 200. When the mouse hovers over a sub-collection 202, the system 100 triggers the activation of the appropriate section of the screen, highlights the section and displays the name attribute for the activated sub-collection 200 to the user.

In one embodiment of the system 100, the paging controls include basic paging tasks translated into key bindings for a mouse 104, depending on the number of bindings available and supported buttons/controls, as well as a selected user preference. For example, the paging controls may include identifying a section of paged data. This may be done by way of detecting the location of the mouse pointer 204 at any given time and having the browser 102 map the location of the pointer 204 to a collection 200 in whose boundaries the pointer 204 is located. The identified collection 200, if identified as page-able in the markup, may become active similar to an active window on a desktop when clicked or hovered upon.

The paging controls may also include executing page forward and page backward actions. A previously designated HTML/JavaScript control may be activated as soon as the appropriate button is pressed on the mouse 104 or other mouse action is performed to either page the content forward or backward. The paging controls may also include a view all action. A previously designated HTML/JavaScript control may be activated as soon as the appropriate mouse action is performed on the mouse 104 to view all the paged content in the section in a single window, such that the content is no longer paged. The paging controls may also include first page and last page controls that allow a user to perform a mouse action to jump to either the first page of the paged content or the last page of the paged content. The web page developer may be responsible for mapping any required coding or controls on the page to allow the system to bind the paging controls to the mouse actions.

The paging controls may also include a jump-to-page-number action that allows a user to specify a certain page number of the paged content to which the user would like to jump. In the jump-to-page-number action, a web developer may designate a standard method of jumping to a particular page. One method may be by requesting that the user specify the page number input and then either paging through the content on the client-side or by building a new uniform resource locator (URL) with the specified paging parameter. Either method may require user input, so that the browser 102 is responsible for querying the user for the page number in a specific way. The design of the query may allow the user to select the page number using only the mouse 104. One embodiment includes a simple display of a number that may be incremented or decremented by operating the scrolling wheel on the mouse 104. Another embodiment displays a visualization of a wheel or scroll column of numbers that the user may use to select a number directly with the pointer or by scrolling with the mouse's scroll wheel. In either embodiment, the input may appear directly over the activated collection 200 so that the user may keep the mouse pointer 204 in the activated collection 200. Alternatively, the browser 102 may highlight the collection (if it is too small to contain the user input) and display at least part of the visualization outside of the collection 200 such that the user is able to clearly identify the collection 200 receiving the jump-to-page-number input. The system may implement other paging controls in addition to or instead of those described herein.

In one embodiment, each collection 200 is identified by designation via a microformat rather than using a link relation. Microformat allows the browser 102 to understand the semantic meanings of content on the web page by using cascading style sheet classes. The browser 102 may be configured to optionally do the binding by searching for a collection 200 class name and then recording the name attribute, rather than keying off of the relation attribute of the DOM element. This may allow the user to select whichever method appears to be most common in the pages most frequently visited or otherwise.

The user may be able to enable or disable the implementation of the mapping in the browser 102 either through a preferences selection or during operation by pressing a keyboard key, such as the escape key. The system 100 may also be fully accessible and provide support for blind or visually impaired users by voicing the name attribute of a collection 200, the current page, or any of the actions using a conventional screen reader. Additionally, the user may not be required to learn and use keyboard hotkeys, and may be able to discover the different sections on the web page more efficiently using the mouse 104 instead of using a tab key and sequentially navigating all the markup elements on the page. The system 100 may be implemented using HTML designators as described herein and may be installed in the browser 102 via a plug-in to the HTML parsing and rendering engine.

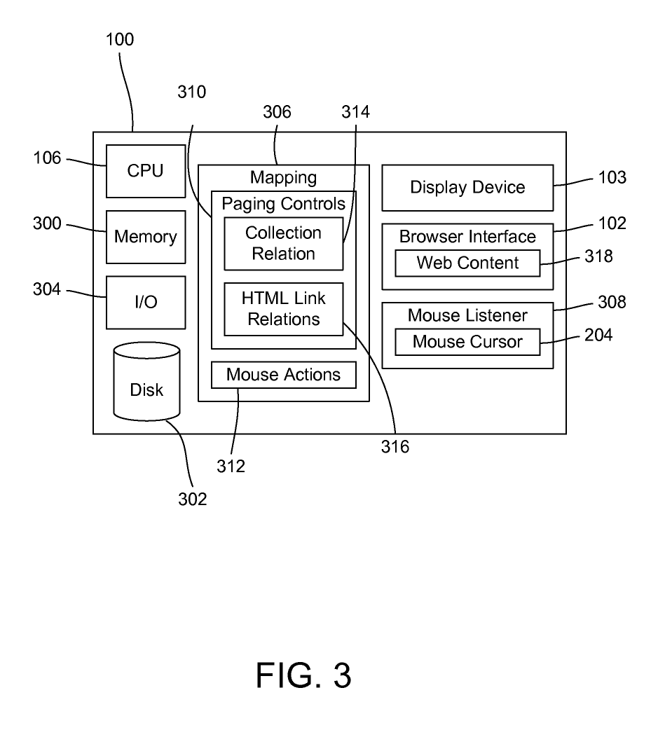

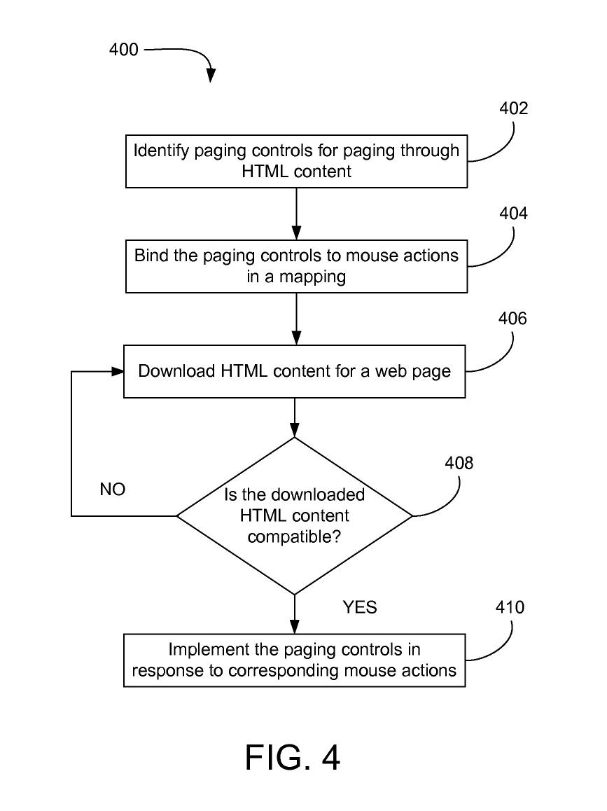

FIG. 3 depicts a schematic diagram of one embodiment of the universal paging system 100 of FIG. 1. The depicted universal paging system 100 includes various components, described in more detail below, that are capable of performing the functions and operations described herein. In one embodiment, at least some of the components of the universal paging system 100 are implemented in a computer system. For example, the functionality of one or more components of the system 100 may be implemented by computer program instructions stored on a computer memory device 300 and executed by a processing device 106 such as a CPU. The system 100 may include other components, such as a disk storage drive 302, input/output devices 304, a mapping 306, a browser interface 102, a display device 103, and a mouse listener 308. Some or all of the components of the system 100 may be stored on a single computer, a network of computers, or on remotely connected computing devices. The system 100 may include more or fewer components than those depicted herein. In some embodiments, the system 100 may be used to implement the methods described herein as depicted in FIG. 4.

According to one embodiment, the mapping 306 includes paging controls 310 bound to mouse actions 312. The paging controls 310 may include any combination of paging controls 310 for use in a web page that allows a user to page through paged content in a specified section of the web page. The paging controls 310 may be bound to mouse actions 312 according to a number of mouse actions 312 available for binding and paging controls 310 allowed by the web page. In one embodiment, the paging controls 310 include a collection relation 314 that corresponds to a particular section of the web page. The paging controls 310 may also include link relations 316 that are supported inherently by HTML. The mapping 306 may be stored on a profile 108 that is stored on the disk storage drive 302 or on another storage device either locally or remotely. The profile 108 may be user-modifiable, allowing the user to adjust or create bindings between mouse actions 312 and paging controls 310.

The browser interface 102, which is displayed on the display device 103, downloads and parses web content 318 from the remote web page server 110. The web content 318 may include all content corresponding to the currently viewed web page such that the content is viewable by the user in the browser interface 102. The web content 318 may include a name attribute for each collection 200 in the web page. The browser interface 102 may also be configured to visually emphasize a presently activated collection 200 and/or display a name attribute on the screen corresponding to the activated collection 200. After parsing the web content 318, the browser interface 102 determines whether the web content 318 is compatible with the universal paging system 100. In one embodiment, the web content 318 contains tags or other markers in the HTML to indicate to the browser interface 102 that the web page is compatible with the universal paging system 100.

The mouse listener 308 listens for mouse actions 312 input by the user into the browser interface 102 or while the browser interface 102 is in focus on the computing device. The mouse listener 308 may also be configured to detect a position of the mouse cursor 204 within the web page. The position of the mouse cursor 204 may determine which collection 200 is activated, such that as the mouse 104 is moved across the web page, the currently activated collection 200 may change. The collection 200 may be based on a collection correlation defined in the HTML code. When a collection 200 is activated, mouse actions 312 bound to paging controls are implemented within the activated collection 200.

FIG. 4 depicts a flow chart diagram of one embodiment of a method 400 for universal paging in a web browser 102. Although the method 400 is described in conjunction with the universal paging system 100 of FIG. 1, embodiments of the method 400 may be implemented with other types of universal paging systems 100.

The universal paging system 100 identifies 402 a list of paging controls 310 for paging through a plurality of pages including HTML web content 318. The paging controls 310 may include HTML-supported paging actions, such as those supported by HTML5, such as “last”, “start”, “first”, “previous”, “next”, and “index” that allow a user to navigate through paged content on a web page. The paged content may include JavaScript code that allows for richer content on the page or more complexity on the page. In one embodiment, the paging controls 310 include a collection relation for each collection 200 in downloaded web content 318. The collections 200 correspond to individual sections of the web page that may be visually separated on a screen in the browser interface 102. Some or all of the collections 200 may include paged content. In some embodiments, one or more of the collections 200 on a single page may include subset collections 202 (also referred to as sub-collections 202) nested within the collections 200.

The system 100 then binds 404 the list of paging controls 310 to a set of mouse actions 312 in a mapping 306. Each mouse action 312 is bound to one of the paging controls 310 in the list. In one embodiment, the mouse actions 312 include clicking a mouse button or a combination of mouse buttons in a specific sequence. The mouse actions 312 may include other user-interactions with the mouse 104, such as scrolling or mouse gestures. The mapping 306 of paging controls 310 to mouse actions 312 may be stored in a profile 108 either locally or remotely. The profile 108 may be specific to the user or to the computing device. The mapping 306 may be stored in the profile 108 in any compatible data structure in a memory device 300, such as a tree, and the browser interface 102 or computer processor 106 may be able to access the mapping 306 at any time. In some embodiments, the user is able to modify the mapping 306 according to preferences in a user profile 108. The user profile 108 may be accessed through a plug-in for the browser interface 102 or through another application.

The system 100 downloads 406 the HTML content 318 for a web page from a server 110. The system determines 408 whether the content 318 is compatible with the mapping 306 by parsing and comparing the downloaded content 318 to the paging controls 310. In various embodiments, some, all or none of the downloaded content 318 is compatible with the paging controls 310. The system 100 then implements 410 the mapping 306 for web pages that are encoded to recognize the mapping 306. The source HTML code for the web page may include tags within or other indicators that the system 100 may identify in determining which paging controls 310 are compatible with the web page and which mappings 306 are enabled.

The system 100 may distinguish the collections 200 from each other and determine the collection 200 in which the paging controls 310 will be implemented 410 upon performing mouse actions 312. In one embodiment, the system 100 may detect a position of the mouse cursor 204 on the web page. If the mouse cursor 204 is detected within the boundaries of an identifiable collection 200, the system 100 activates the collection 200 and implements 410 paging controls 310 within that collection 200 in response to mouse actions 312. In one example, if the mouse 104 is positioned within the boundaries of a sub-collection 202 inside of a larger collection 200, the sub-collection 202 is activated. As the mouse cursor 204 moves across the screen, the activated collection 200 may change according to the position of the mouse cursor 204. In some embodiments, the activated collection 200 may be determined by other methods, such as by performing a specific mouse action 312.

In some embodiments, the system 100 visually emphasizes the activated collection 200 where the mouse cursor 204 is positioned and displays a name attribute corresponding to the collection 200. The name attribute may be extracted from the web content 318 and displayed in a pop-up or using some other display mechanism, such that the user is able to know which collection 200 is presently activated. The system 100 may visually emphasize the activated collection 200 by coloring or otherwise highlighting the border of the collection 200, or the system 100 may use other methods of giving visual cues to the user to identify the currently activated collection 200.

An embodiment of a universal paging system 100 includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation for universal paging in a web browser. The operations may include identifying a list of paging controls for paging through paged HTML content, binding the list of paging controls to a set of mouse actions in a mapping, and implementing the mapping for web pages that are encoded to recognize the mapping.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. A computer readable storage medium is a specific type of computer-readable or -usable medium. Examples of a computer-readable storage medium include a semiconductor or solid state memory, magnetic tape, a removable computer diskette, a random access memory (RAM), a read-only memory (ROM), a rigid magnetic disk, and an optical disk. Hardware implementations including computer readable storage media also may or may not include transitory media. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product, comprising:
a computer readable storage medium to store a computer readable program, wherein the computer readable program, when executed by a processor within a computer, causes the computer to perform operations for universal paging in a web browser, the operations comprising:
identifying a list of paging controls for paging through a plurality of pages of Hypertext Markup Language (HTML) content;
binding the list of paging controls to a set of mouse actions in a mapping stored on a memory device, wherein each mouse action is bound to one of the paging controls in the list; and
implementing the paging controls for web pages displayed on a display device in response to corresponding mouse actions from the mapping, wherein the web pages are encoded to recognize the mapping.

2. The computer program product of claim 1, wherein the computer program product, when executed on the computer, causes the computer to perform additional operations, comprising:
modifying the mapping according to preferences in a user profile.

3. The computer program product of claim 1, wherein the paging controls comprise HTML-supported paging actions.

4. The computer program product of claim 1, wherein the paging controls comprise a jump-to-page control, wherein the computer program product, when executed on the computer, causes the computer to perform additional operations, comprising:
receiving an input from a user in addition to the corresponding mouse action, wherein the input indicates a page number in the pages of HTML content to which the jump-to-page control jumps.

5. The computer program product of claim 1, wherein the list of paging controls comprises a collection relation, wherein the collection relation describes a specific paged portion of a compatible web page.

6. The computer program product of claim 5, wherein the computer program product, when executed on the computer, causes the computer to perform additional operations, comprising:
detecting a position of a mouse cursor displayed relative to the web page, wherein the position corresponds to a collection based on the collection relation; and
implementing the paging controls within the collection in response to the mouse actions.

7. The computer program product of claim 6, wherein the computer program product, when executed on the computer, causes the computer to perform additional operations, comprising:
visually emphasizing the collection corresponding to the position of the mouse cursor is positioned;
displaying a name attribute corresponding to the collection, wherein the name attribute is extracted from the HTML content; and
voicing the name attribute.

8. The computer program product of claim 6, wherein the collection comprises subset collections.

9. A method for universal paging in a web browser, the method comprising:
identifying a list of paging controls for paging through a plurality of pages comprising Hypertext Markup Language (HTML) content;
binding the list of paging controls to a set of mouse actions in a mapping stored on a memory device, wherein each mouse action is bound to one of the paging controls in the list; and
implementing the paging controls for web pages displayed on a display device in response to corresponding mouse actions from the mapping, wherein the web pages are encoded to recognize the mapping.

10. The method of claim 9, comprising:
modifying the mapping according to preferences in a user profile.

11. The method of claim 9, wherein the paging controls comprise HTML-supported paging actions.

12. The method of claim 9, wherein the list of paging controls comprises a collection relation, wherein the collection relation describes a specific paged portion of a web page.

13. The method of claim 12, comprising:
detecting a position of a mouse cursor displayed relative to the web page, wherein the position corresponds to a collection based on the collection relation; and
implementing the paging controls within the collection in response to the mouse actions.

14. The method of claim 13, comprising:
visually emphasizing the collection corresponding to the position of the mouse cursor is positioned;
displaying a name attribute corresponding to the collection, wherein the name attribute is extracted from the HTML content; and
voicing the name attribute.

15. A universal paging system for web browsing on a computing device, the system comprising:
a mouse listener to listen for mouse actions;
a mapping data structure stored on a memory device, wherein the mapping data structure comprises a list of paging controls bound to a set of mouse actions, wherein the paging controls are for paging through a plurality of pages comprising Hypertext Markup Language (HTML) content, wherein each mouse action is bound to one of the paging controls in the list; and
a browser interface displayed on a display device to download and parse web content, wherein the browser interface is also configured to implementing the paging controls in response to corresponding mouse actions from the mapping for web pages that are encoded to recognize the mapping.

16. The system of claim 15, wherein the mapping is at least partially user-defined according to preferences in a user profile.

17. The system of claim 15, wherein the paging controls comprise HTML-supported paging actions.

18. The system of claim 15, wherein the paging controls comprise a collection relation, wherein the collection relation describes a specific paged portion of a compatible web page.

19. The system of claim 18, wherein the mouse listener is further configured to detect a position of a mouse cursor on the web page, wherein the position corresponds to a collection based on the collection relation, wherein the browser interface is configured to implement the paging controls within the collection in response to the mouse actions.

20. The system of claim 19, wherein the browser interface is further configured to visually emphasize the collection corresponding to the position of the mouse cursor is positioned and display a name attribute corresponding to the collection, wherein the name attribute is extracted from the web content.
